(19) United States
(12) Patent Application Publication
(10) Pub. No.: US 2002/0020034 A1
(43) Pub. Date: Feb. 21, 2002

(54) Windshield wiper arm

(76) Inventor: Kwang-Je Choi, Kwangwondo (KR)

Correspondence Address: DANN DORFMAN HERRELL & SKILLMAN, SUITE 720, 1601 MARKET STREET, PHILADELPHIA, PA, 19103-2307, US

(21) Appl. No.: 09/872,044

(22) Filed: Jun. 1, 2001

(30) Foreign Application Priority Data
Jun. 1, 2000 (KR) 30169/2000

(51) Int. Cl. B60S 1/34

(52) U.S. Cl. 15/250.351; 15/250.352

(57) ABSTRACT

A windshield wiper arm is provided with a multi-frequency broadband receiving antenna function so as to reduce the count of antennas to be attached to motor vehicles, aircraft, ship and the like, to thereby reduce the cost related to design and manufacture of antenna and improve operational safety. The combined antenna and windshield wiper arm includes an arm head; a retainer coupled to be rotatable to the arm head and which has a sleeve portion with a closed cross section; an arm piece coupled to an end of the retainer through an electric insulator as a medium; and an elastic member one end of which is coupled to be electrically conductible to the arm piece and the other end of which is coupled to the arm head through an electric insulator as a medium.

### BACKGROUND OF THE INVENTION

1. Field of the Invention

The present invention relates to a combined antenna and windshield wiper arm, and more particularly, to a windshield wiper arm in which the windshield wiper is provided with a multi-frequency broadband receiving antenna function so as to reduce the count of antennas to be attached to motor vehicles, aircraft, ship and the like, to thereby reduce the cost related to design and manufacture of antenna and improve operational safety.

2. Description of Related Art

Automobile antenna systems adopt AM/FM radio receiving antenna which requires an additional pole antenna having a length corresponding to one-fourth wavelength of FM radio frequency or uses hot wire of rear window glass. Automobile remote starters, theft alarm system or TSR communication antennas have frequency band different from that of radio system, an antenna in addition to a radio receiving antenna is required.

Since aircraft employs VOR and ISL antennas related to aircraft operation, the aircraft becomes complex in design. Furthermore, production cost and assembly process increase since each antenna has to be produced and assembled through additional procedures.

To overcome the above-discussed problems, there has been proposed an approach of adding antenna function to a windshield wiper. However, such conventional art combination antenna and windshield wiper only utilizes the electric conductor portion of the wiper. In other words, such conventional art combination antenna and windshield wiper is only a development where a conventional pole antenna, i.e., whip antenna, is replaced with a wiper, thus failed to satisfy a recent increase in using various communications equipment. Further, few windshield wipers have been developed which have high sensitivity or efficiency.

### SUMMARY OF THE INVENTION

Therefore, it is an object of the present invention to provide a windshield wiper arm in which the windshield wiper is capable of performing multi-frequency sleeve antenna function while at the same time maintaining unique function of windshield wiper.

In accordance with the present invention, there is provided a combined antenna and windshield wiper arm including an arm head; a retainer coupled to be rotatable to the arm head and which has a sleeve portion with a closed cross section; an arm piece coupled to an end of the retainer through an electric insulator as a medium; and an elastic member one end of which is coupled to be electrically conductible to the arm piece and the other end of which is coupled to the arm head through an electric insulator as a medium.

Preferably, the sleeve portion of the retainer is provided with a dielectric member incorporated therein.

Differently from a simple pole antenna, thus-configured combined antenna and windshield wiper arm of the present invention allows the combination to function as a perpendicular polarization radiating non-directional sleeve antenna having a sleeve arranged at an exterior of a linear conductor. Therefore, communications equipment for a variety of frequency bands can be utilized without mounting additional antennas.

The arm piece is equipped with, at a free end thereof, a top loading having a proper shape in accordance with the frequency or use, to thereby increase effective length and lower characteristic frequency of the combined antenna and windshield wiper arm.

Preferably, the retainer or the arm piece is made up of electrical conductors in consideration of enhanced performance, and more preferably, it would be more preferable to have the retainer or the arm piece made up of steel and coated with an electrical conductor plated layer formed at the surface thereof, in view of the manufacturing cost and stiffness.

There exists a likelihood of deterioration of efficiency caused when the signal may by-pass to ground via rain water during rain, it is therefore preferable to coat the surface of the conductor with a water proof electric insulator, to thereby prevent deterioration of efficiency.

### BRIEF DESCRIPTION OF THE DRAWINGS

FIG. 1 is an perspective view illustrating a combined antenna and windshield wiper arm according to an embodiment of the present invention;

FIG. 2 is a sectional view illustrating an assembled state of the combined antenna and windshield wiper arm shown in FIG. 1;

FIGS. 3 to 5 are graphical presentations of reflection coefficient with respect to the frequency of a wiper arm antenna; and

FIG. 6 illustrates a windshield wiper arm equipped with a top loading according to another embodiment of the present invention.

### DETAILED DESCRIPTION OF THE INVENTION

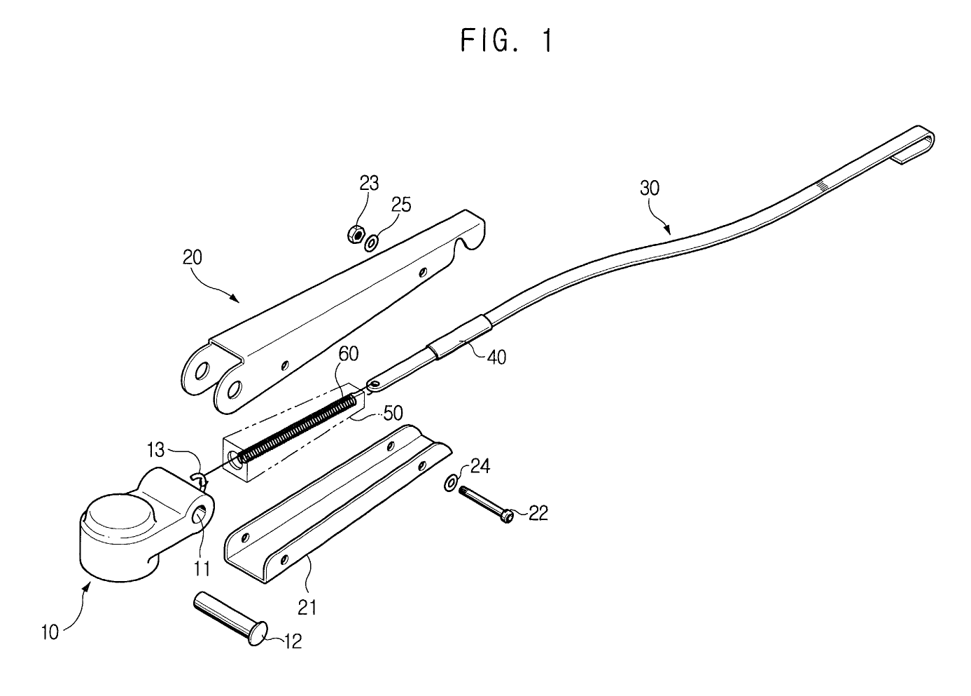

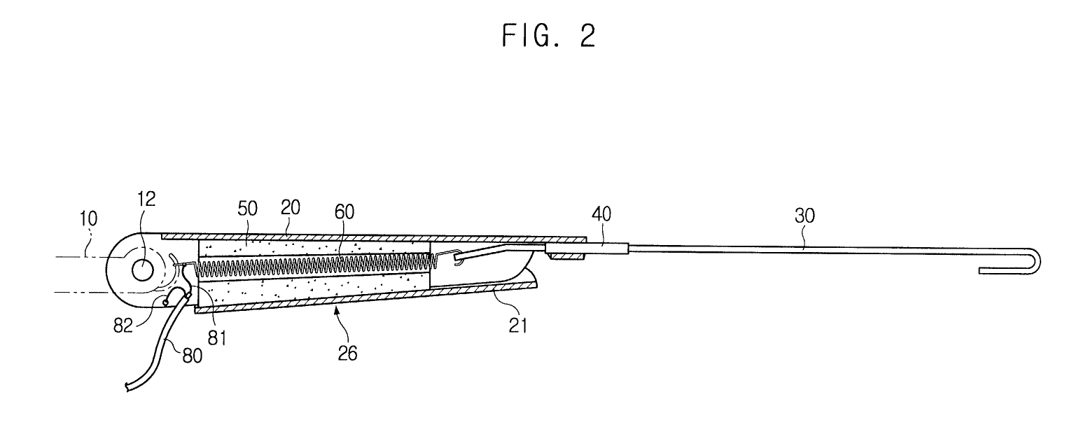

Referring to FIGS. 1 and 2, a wiper arm of the present invention is same as a conventional art, in that a retainer 20 is coupled to be rotatable to a hinge hole 11 of an arm head 10 via a hinge pin 12 as a medium, and an arm piece 30 is coupled to an end of the retainer. However, the present invention is characterized in that a sleeve plate 21 is coupled to an opening of the retainer 20 so as to allow the coupled structure to have a cross section of electrically closed curve. An electrical insulator 40 is mounted at the portion where the arm piece and the retainer are coupled, so as to thereby electrically isolate the arm piece from the retainer. As a consequence, the arm piece 30, i.e., linear conductor, is inserted into an inner space formed in a sleeve portion 26, i.e., closed cross section of the retainer.

Although the embodiment of the present invention is described by taking an example of forming the sleeve portion by coupling the sleeve plate to the opening of the retainer, it is also possible to form a sleeve plate by press bending the opening of the retainer and coupling the sleeve plate to the opening through a soldering process or the like.

A dielectric member 50 with a perforation 51 formed in lengthwise direction of the dielectric member is disposed within the sleeve portion 26, and a spring 60 is mounted through the perforation 51.

The spring 60 has an end coupled to be electrically conductible to the arm piece 30 and the other end coupled to the arm head 10 to be electrically insulated therefrom. As a consequence, the arm piece 30 as a linear conductor is extended throughout the sleeve portion 26 via the spring 60 which is a conductor.

Polyethylene or polyurethane resin can be used as the dielectric member disposed within the sleeve portion. Alternatively, the air can be used as the dielectric member eliminating the necessity of disposing an additional dielectric member.

The insulating coupling between the spring and the arm head can be achieve by engaging the spring to a hook 13 of the arm head which is formed of a non-conductor, or by arranging a non-conductor medium between the hook and the spring.

Reference numerals 22, 23, 24 and 25 denote a bolt, nut and a washer for coupling the sleeve plate 21 to the retainer 20.

In general, windshield wiper arms are manufactured by materials such as iron or steel so as to obtain a high mechanical strength. However, those materials are not desirable as materials of antennas receiving weak electromagnetic waves. Therefore, it is preferable to coat the wiper arm with conductors like copper, silver or aluminum so as to obtain a high efficiency antenna. When a water proof insulator is coated to the surface of conductor for insulation from the vehicle body during rain, the electric wave leakage through ground can be minimized, and at the same time, the wiper arm can be prevented from corrosion. Furthermore, wiper arms with enhanced aesthetic enhancement can be manufactured since it is possible to use any paint having a color matching to the color of the vehicle body.

It is a common knowledge that automobiles or aircraft are equipped with a plurality of windshield wipers. When the combined antenna and windshield wiper arm of the present invention is applied to each of windshield wipers for automobiles or aircraft, a high sensitivity and high efficiency receiving performance can be obtained and noise can be minimized as compared with the case where a single antenna is employed.

Each component of the wiper arm of the present invention performs the characteristic function of wiper, and at the same time, the function corresponding to the components of a multi-frequency sleeve antenna.

Multi-frequency sleeve antennas are configured in that the outer surface of the sleeve portion operates as an antenna for radiating electromagnetic wave and the inner section of the sleeve portion and the metallic conductor functions as an impedance match circuit. Since the reactance of the sleeve portion of multi-frequency sleeve antennas operates as an inductance or capacitance in accordance with frequency, resonance frequency can have diversity. The arm piece 30 and the spring 60 electrically coupled thereto, according to the present invention, correspond to the metallic conductor section of the multi-frequency sleeve antenna, while the sleeve portion 26 of the present invention corresponds to the sleeve portion of the multi-frequency sleeve antenna.

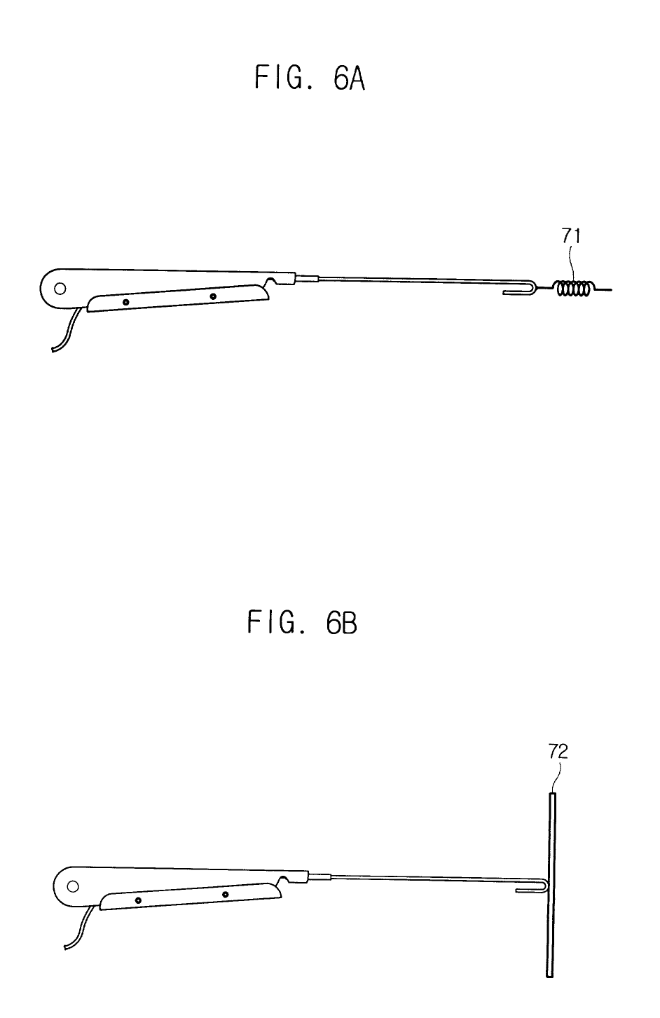

When the wiper arm of the present invention is in actually applied, an inner conductor 71 of a coaxial feeder 70 is connected (feeding point) to an end of the spring 60, and an outer conductor 72 of the coaxial feeder 70 is connected to the retainer 20, as shown in FIGS. 6a and 6b. Thus, the retainer is coupled to the vehicle body via the arm header, thereby achieving earthing effect.

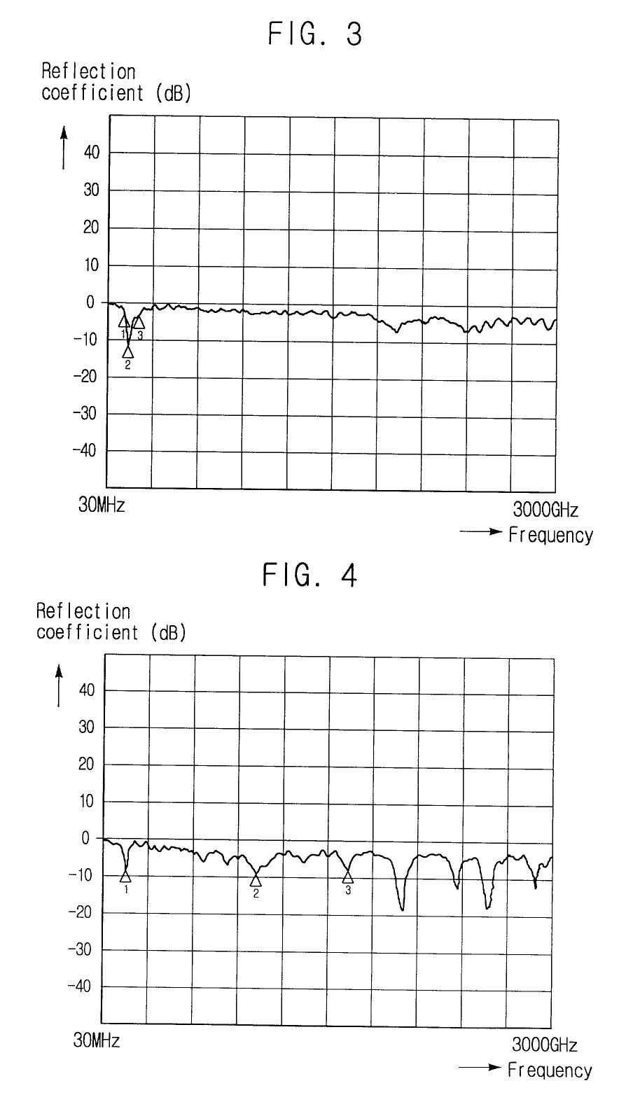

FIGS. 3 to 5 illustrate antenna performance test result of the combined antenna and windshield wiper arm of the present invention, wherein the change of reflection coefficient according to the frequency is illustrated.

FIG. 3 illustrates a case where the windshield wiper arm has the total length (i.e., the length from the feeding point to an end of the arm piece) of 0.5 m, the sleeve portion has a length of 0.15 m, and the sleeve portion has an inner conductor with a diameter of 3.1 mm and a length of 0.125 m. When the frequency at mark 2 is 150.40 MHz (central frequency), the wiper arm operates as a single frequency broadband antenna of a reflection coefficient −10.7 dB and bandwidth 100 MHz approximately.

FIG. 4 illustrates a case where the windshield wiper arm has the total length and the sleeve portion length same as those of the case described with reference to FIG. 3, and the inner conductor is made up of a spring formed by winding ten turns the conductor having a diameter of 3.1 mm and a length of 0.3 m. As shown in FIG. 4, the wiper operates as a multi-frequency antenna having a reflection coefficient of −7.84 dB when the frequency at mark 1 is 163.0 MHz, reflection coefficient of −8.64 dB when the frequency at mark 2 is 1.03 GHz, and reflection coefficient of −7.71 dB when the frequency at mark 3 is 1.64 GHz.

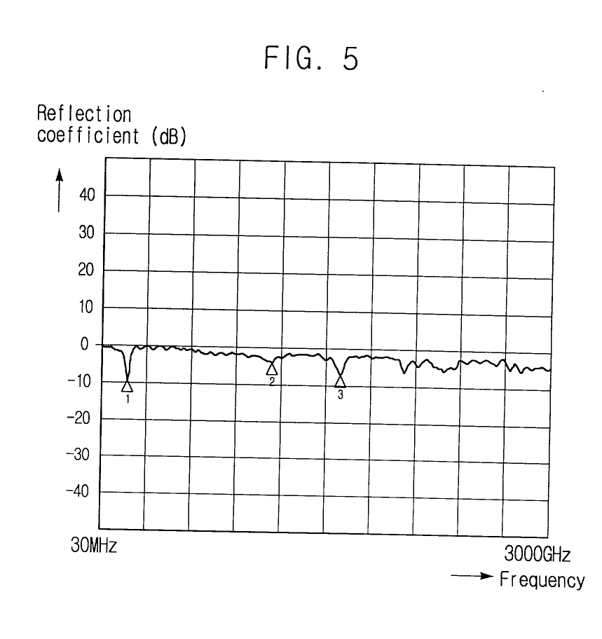

FIG. 5 illustrates a case where the windshield wiper arm has the total length and the sleeve portion length same as those of the case described with reference to FIG. 3, and the inner conductor is made up of a spring formed by winding five turns the conductor having a diameter of 1.65 mm and a length of 0.2 m. As shown in FIG. 5, the wiper operates as a multi-frequency antenna having a reflection coefficient of −9.23 dB when the frequency at mark 1 is 179.5 MHz, reflection coefficient of −4.03 dB when the frequency at mark 2 is 1.14 GHz, and reflection coefficient of −7.19 dB when the frequency at mark 3 is 1.60 GHz.

As can be seen from the above-described test result, the combined antenna and windshield wiper arm of the present invention renders it possible to design a multi-frequency antenna even when the total length of the wiper arm or the sleeve portion length is constant. In addition, even when the total length of the wiper arm or the sleeve portion length are restricted in accordance with the condition of the mount portion, the type of dielectric substance filling the sleeve portion, and the thickness and shape of the conductor arranged within the sleeve portion can be determined in accordance with the frequency or use, to thereby obtain the desired resonance frequency.

As shown in FIGS. 6a and 6b, the arm piece is equipped with a top loading 71 or 72 in accordance with the frequency or use, thus increasing effective length and lowering characteristic frequency of the combined antenna and windshield wiper.

As described above, the combined antenna and windshield wiper arm of the present invention permits the function of multi-frequency broadband receiving antenna so as to reduce the count of antennas to be attached to motor vehicles, aircraft, ship and the like, to thereby reduce the cost related to design and manufacture of antenna and improve operational safety.

Furthermore, an air resistance caused by an antenna projected outwardly from motor vehicles, aircraft and ship can be minimized.

What is claimed is:

1. A windshield wiper arm comprising:
an arm head;
a retainer coupled to be rotatable to said arm head and which has a sleeve portion with a closed cross section;
an arm piece coupled to an end of said retainer through an electric insulator as a medium; and
an elastic member one end of which is coupled to be electrically conductible to said arm piece and the other end of which is coupled to said arm head through an electric insulator as a medium.

2. A windshield wiper arm according to claim 1, wherein said sleeve portion has at an interior thereof a dielectric member

3. A windshield wiper arm according to claim 1, wherein said arm piece has at a free end thereof a top loading.

4. A windshield wiper arm according to claim 1, wherein one of said retainer or said arm piece has at a surface thereof an electrical conductor plated layer.

5. A windshield wiper arm according to claim 1 or claim 4, wherein said windshield wiper arm has a surface coated with a water proof insulator.
